(19) United States
(12) Patent Application Publication
(10) Pub. No.: US 2007/0283925 A1
(43) Pub. Date: Dec. 13, 2007

(54) Controller for vane-type variable valve timing adjusting mechanism

(75) Inventors: Wataru Nagashima, Kariya-city (JP); Toshifumi Hayami, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/797,502

(22) Filed: May 3, 2007

(30) Foreign Application Priority Data
May 19, 2006 (JP) 2006-140890

(51) Int. Cl. F02P 5/145

(52) U.S. Cl. 123/406.12

(57) ABSTRACT

A variable valve timing adjusting mechanism includes one-way valves in a hydraulic supply passage in an advance hydraulic chamber and in a retard hydraulic chamber respectively and a drain oil passage bypassing each of the one-way valves disposed in parallel in the hydraulic supply passage of each hydraulic chamber. Drain switching valves are disposed in the respective drain oil passages. A controller opens the drain switching valve in a side of the hydraulic chamber where oil is discharged when a deviation between a target displacement angle and an actual displacement angle is more than a predetermined value to perform the maximum speed control for driving the adjusting mechanism in a direction of the target displacement angle at the maximum speed. The controller closes the drain switching valve in a side of the hydraulic chamber where oil is discharged when the deviation between the target displacement angle and the actual displacement angle is small to perform the holding control for stopping/slowing the variable operation of the adjusting mechanism.

### CROSS REFERENCE TO RELATED APPLICATION

This application is based on Japanese Patent Application No. 2006-140890 filed on May 19, 2006, the disclosure of which is incorporated herein by reference.

### FIELD OF THE INVENTION

The present invention relates to a controller for a vane-type variable valve timing adjusting mechanism in which one-way valves are disposed in a hydraulic supply passage of an advance hydraulic chamber and in a hydraulic supply passage of a retard hydraulic chamber respectively for preventing reverse flow of operating oil from the respective hydraulic chambers.

### BACKGROUND OF THE INVENTION

A vane-type variable valve timing adjusting mechanism is, as shown in JP-2001-159330A (U.S. Pat. No. 6,330,870B1), adapted in such a manner that a housing rotating in a timed relation to a crank shaft of an engine is disposed coaxially with a vane rotor connected to a cam shaft of an intake valve (or exhaust valve) and a plurality of vane-accommodating chambers formed in the housing respectively are divided into an advance hydraulic chamber and a retard hydraulic chamber by vanes (blade portions) at the outer periphery of the vane rotor. In addition, the hydraulic pressure in each hydraulic chamber is designed to be controlled by a hydraulic control valve to rotate the vane rotor relative to the housing, so that a displacement angle of the camshaft (camshaft phase) to the crankshaft is varied to variably control valve timing.

In such vane-type variable valve timing adjusting mechanism, at the time of opening/closing the intake valve or the exhaust valve during engine operating, fluctuations of friction torque which the cam shaft receives from the intake valve or the exhaust valve are transmitted to the vane rotor. In consequence, torque fluctuations in the retard direction or in the advance direction are exerted on the vane rotor. Thereby, when the vane rotor is subjected to torque fluctuations in the retard direction, the operating oil in the advance hydraulic chamber is to be subjected to such pressure as to be pushed out of the advance hydraulic chamber or when the vane rotor is subjected to torque fluctuations in the advance direction, the operating oil in the retard hydraulic chamber is to be subjected to such pressure as to be pushed out of the retard hydraulic chamber. In consequence, in a low-rotation region where pressures supplied from a hydraulic supply source are low, even when a displacement angle of the cam shaft is designed to be advanced by supplying the hydraulic pressure to the advance hydraulic chamber, the vane rotor is, as shown in a dotted line of FIG. 3, pushed back in the retard direction due to the torque fluctuations. As a result, the response time to a target displacement angle of the vane rotor is longer.

In order to solve this problem, as shown in JP-2003-106115A (U.S. Pat. No. 6,763,791 B2), a one-way valve is disposed in each of a hydraulic supply passage of an advance hydraulic chamber and a hydraulic supply passage of a retard hydraulic chamber for preventing reverse flow of operating oil from the advance hydraulic chamber or the retard hydraulic chamber. Thereby, as shown in a solid line of FIG. 3, it is considered that this one-way valve is adapted to prevent the vane rotor from being pushed back in the reverse direction to the direction of a target displacement angle during variable valve timing controlling, improving response characteristic of the variable valve timing control.

In the variable valve timing adjusting mechanism, the one-way valve is disposed in each of the hydraulic supply passage of the advance hydraulic chamber and the hydraulic supply passage of the retard hydraulic chamber (hydraulic introduction line) and also a returning line (hydraulic discharge line) is disposed in parallel to the hydraulic supply passage of each hydraulic chamber for bypassing the one-way valve. As a result, this controller provides a structure where a function as a line switching valve for opening/closing the returning line of each hydraulic chamber is united to a hydraulic control valve (spool-type electromagnetic valve) controlling the hydraulic pressure supplied to each hydraulic chamber. Further, a control current value of the hydraulic control valve is controlled to control the hydraulic pressure supplied to each hydraulic chamber and at the same time, to control the switching in opening/closing of the returning line of each hydraulic chamber. Hereby, when the hydraulic pressure in each hydraulic chamber is required to be released, this controller is adapted to release the hydraulic pressure through the returning line by opening the returning line of the corresponding hydraulic chamber.

In this variable valve timing adjusting mechanism, however, an armature in the hydraulic control valve is driven by an electric variable force solenoid to increase the entire length of the controller in the cam shaft direction, deteriorating the mounting properties.

The present applicant has proposed a variable valve timing adjusting mechanism having the structure where drain oil passages bypassing one-way valves are provided with drain switching valves disposed therein and driven by hydraulic pressures, and an electromagnetic type hydraulic switching valve for switching the hydraulic pressure driving each drain switching valve is disposed. Since in this structure, the drain switching valve can be small-sized and electrical wiring to the drain switching valve is not required, the drain switching valve together with the one-way valve can be downsized to be incorporated in a narrow space inside the variable valve timing adjusting mechanism. Further, since the hydraulic switching valve and the hydraulic control valve for controlling the hydraulic pressure supplied to each hydraulic chamber in the variable valve timing adjusting mechanism are not required to be mounted directly to the cam shaft, this variable valve timing adjusting mechanism has an advantage that the mounting properties thereof improve. It should be noted that the present applicant has further improved the aforementioned variable valve timing adjusting mechanism and has also proposed a variable valve timing adjusting mechanism having a structure where a single hydraulic control valve switches the hydraulic pressure driving each drain switching valve and controls the hydraulic pressure supplied to each hydraulic chamber in the variable valve timing adjusting mechanism.

The variable valve timing adjusting mechanism the present applicant has proposed is structured in such a manner as to provide a one-way valve and a drain switching valve in a drain oil passage bypassing the one-way valve inside a variable valve timing adjusting mechanism, thereby controlling leakage of operating oil from a hydraulic chamber in the variable valve timing adjusting mechanism. In consequence, the variable valve timing adjusting mechanism has an advantage of improving a response characteristic as compared to the conventional variable valve timing adjusting mechanism.

A variable valve timing control system, as shown in JP-2001-303990A (U.S. Pat. No. 6,539,902B2), performs control of increasing a feedback gain at a transient time of the variable valve timing control in order to enhance a response characteristic at the transient time. However, when the feedback gain is excessively increased, the overshooting occurs to deteriorate a convergent characteristic of an actual displacement angle to a target displacement angle, thereby producing the problem of deteriorating combustion of an engine or the like. In consequence, it raises the problem that the response characteristic of the variable valve timing control is limited in view of prevention of the overshooting.

As a result, when such a variable valve timing control is applied to the control in the variable valve timing adjusting mechanism that the present applicant has proposed, the improved response characteristic as compared to the conventional variable valve timing adjusting mechanism is cancelled out. That is, it raises the problem of being incapable of improving the response characteristic. It should be noted that JP-2003-106115A (U.S. Pat. No. 6,763,791B2) does not disclose the control of the variable valve timing adjusting mechanism having a one-way valve and a drain oil passage bypassing the one-way valve.

### SUMMARY OF THE INVENTION

An object of the present invention is to provide a controller for a vane-type variable valve timing adjusting mechanism which can improve a response characteristic of a variable valve timing control without occurrence of the overshooting.

In order to achieve the above object, a controller for a vane-type variable valve timing adjusting mechanism (hereinafter referred to as “VTC”) in which each of a plurality of vane accommodating chambers formed in a housing is divided into an advance hydraulic chamber and a retard hydraulic chamber by a vane is provided with a one-way valve disposed in each of a hydraulic supply passage of the advance hydraulic chamber and a hydraulic supply passage of the retard hydraulic chamber in at least one of the vane accommodating chambers for preventing reverse flow of operating oil from the each hydraulic chamber, a drain oil passage disposed in parallel to the hydraulic supply passage of the each hydraulic chamber for bypassing the one-way valve, a drain switching valve disposed in each drain oil passage and driven by a hydraulic pressure and a hydraulic switching valve switching the hydraulic pressure driving the each drain switching valve. The controller is further provided with control means for controlling the hydraulic control valve to vary the hydraulic pressure in the each hydraulic chamber so that an actual displacement angle of the VTC be equal to a target displacement angle, and also for opening/closing the drain switching valve of the each hydraulic chamber by controlling the hydraulic switching valve, wherein when a deviation between the target displacement angle and the actual displacement angle is more than a predetermined value, the drain switching valve at the side of the hydraulic chamber where operating oil is discharged is opened to control the hydraulic control valve at a maximum speed control in such a manner as to drive the VTC in a direction of the target displacement angle at a maximum speed or at a high speed close thereto and when the deviation between the target displacement angle and the actual displacement angle becomes smaller, the drain switching valve at the side of the hydraulic chamber where the operating oil is discharged is closed to perform holding control of the hydraulic control valve in such a manner as to stop a variable operation of the VTC or slow a speed thereof.

As in the case of the present invention, in the VTC of disposing the one-way valve in the hydraulic supply passage of the each hydraulic chamber, as well as disposing the drain switching valve in the drain oil passage bypassing the one-way valve in the each hydraulic chamber, when the drain switching valve at the side of the hydraulic chamber where the operating oil is discharged is closed during a variable operation (advance/retard operation) of the VTC, the discharge of the operating oil is stopped at this point to stop the variable operation of the VTC. As a result of using this dynamic characteristic, even when the VTC is driven at the maximum speed, it is possible to rapidly stop the variable operation of the VTC.

In view of this respect, the present invention is structured in such a manner that when a deviation between a target displacement angle and an actual displacement angle is more than a predetermined value, the drain switching valve at the side of the hydraulic chamber where operating oil is discharged is opened to control the hydraulic control valve at a maximum speed control in such a manner as to drive the VTC in a direction of the target displacement angle at a maximum speed or at a high speed close thereto, and when the deviation between the target displacement angle and the actual displacement angle becomes smaller, the drain switching valve at the side of the hydraulic chamber where the operating oil is discharged is closed to switch to the holding control of the hydraulic control valve in such a manner as to stop a variable operation of the VTC or slow a speed thereof. Thereby, the VTC is driven in a direction of the target displacement angle at the maximum speed or at the high speed close thereto until the actual displacement angle comes close to the target displacement angle, so that the drain switching valve can be stopped immediately before reaching to the target displacement angle, thus performing control of abruptly stopping the variable operation of the VTC. Accordingly, the response characteristic of the variable valve timing control can be largely improved without occurrence of the overshooting.

### BRIEF DESCRIPTION OF THE DRAWINGS

FIG. 1 is a schematic diagram showing a variable valve timing adjusting mechanism and a hydraulic control circuit thereof an embodiment of the present invention.

FIGS. 2A, 2B and 2C are diagrams each explaining a retard operation, a holding operation and an advance operation in the variable valve timing adjusting mechanism.

FIG. 3 is a characteristic diagram explaining a difference in VTC response rate at advance operating depending on presence/absence of a one-way valve.

FIG. 4 is a characteristic diagram showing one example of a response characteristic of the variable valve timing adjusting mechanism with a one-way valve.

FIG. 5 is a flow chart explaining the process order of a VTC control routine.

FIG. 6 is a flow chart explaining the process order of a VTC control mode determination routine.

FIG. 7 is a flow chart explaining the process order of an OCV target current calculation routine.

FIG. 8 is a flow chart explaining the process order of a control switching determination threshold value calculation routine.

FIG. 9 is a flow chart explaining the process order of a maximum speed learning routine.

FIG. 10 is a time chart explaining VTC control.

FIG. 11 is a schematic diagram showing a variable valve timing adjusting mechanism and a hydraulic control circuit thereof in another embodiment of the present invention.

FIG. 12 is a schematic diagram showing a variable valve timing adjusting mechanism and a hydraulic control circuit thereof in a different embodiment of the present invention.

### DETAILED DESCRIPTION OF THE EMBODIMENTS

Hereinafter, embodiments for a best mode of carrying out the present invention will be described.

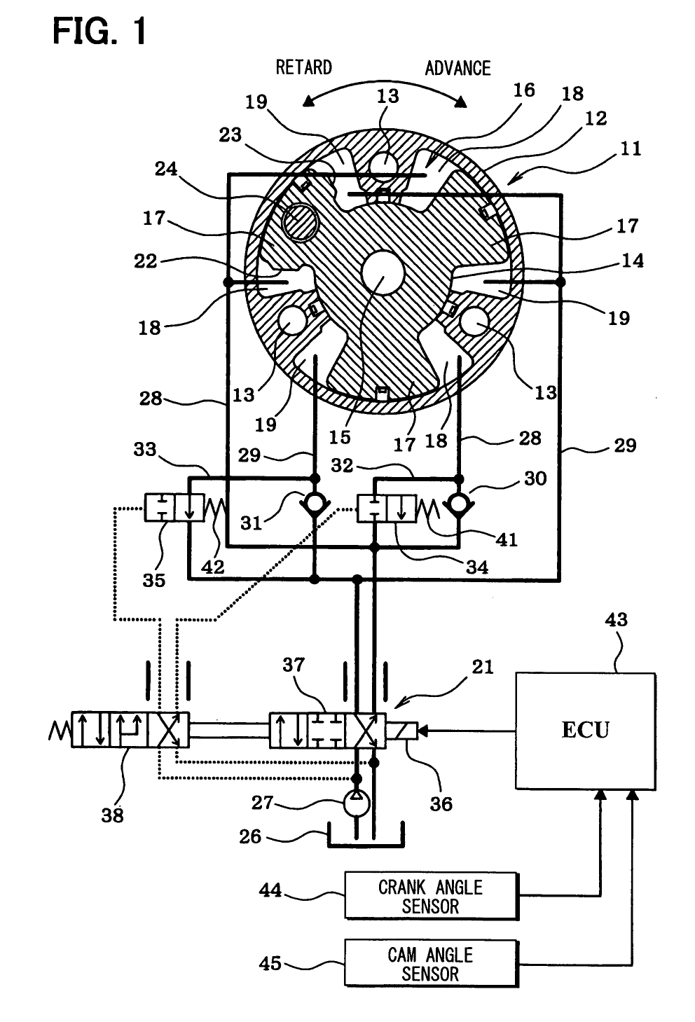

First, a structure of a vane-type variable valve timing adjusting mechanism 11 will be explained with reference to FIG. 1. A housing 12 of the variable valve timing adjusting mechanism 11 is clamped and fixed to a sprocket rotatably supported at an outer periphery of a cam shaft in an intake side or an exhaust side (not shown) by bolts 13. In consequence, rotation of a crankshaft for an engine is transmitted through a timing chain to the sprocket and the housing 12 and the sprocket and the housing 12 rotate in a timed relation to the crankshaft. A vane rotor 14 is accommodated inside the housing 12 so as to rotate relative thereto and is clamped and fixed to one end of the camshaft by a bolt 15.

A plurality of vane accommodating chambers 16 for accommodating a plurality of vanes 17 at an outer periphery of the vane rotor 14 so as to rotate in the advance direction or the retard direction relative to the housing 12 are defined inside the housing 12 and each vane accommodating chamber 16 is divided into an advance hydraulic chamber 18 and a retard hydraulic chamber 19.

At a state where a hydraulic pressure beyond a predetermined pressure is supplied to the advance hydraulic chamber 18 and the retard hydraulic chamber 19, the vane 17 is held by the hydraulic pressures in the advance hydraulic chamber 18 and the retard hydraulic chamber 19 to transmit rotation of the housing 12 caused by rotation of the crank shaft to the vane rotor 14 through the hydraulic pressures, thereby rotating the cam shaft integrally with the vane rotor 14. During engine operating, the hydraulic pressures in the advance hydraulic chamber 18 and the retard hydraulic chamber 19 are controlled by a hydraulic control valve 21 to rotate the vane rotor 14 relative to the housing 12, thereby controlling a displacement angle of the cam shaft (cam shaft phase) to the crank shaft to vary valve timing of an intake valve (or exhaust valve).

In addition, stoppers 22 and 23 for controlling a relative rotational range of the vane rotor 14 to the housing 12 are formed at both side portions of either one of the vanes 17, and the maximum retard position and the maximum advance position of the displacement angle of the cam shaft (cam shaft phase) are restricted by the stoppers 22 and 23. In addition, either one of the vanes 17 is provided with a lock pin 24 disposed therein for locking a displacement angle of the cam shaft at a certain lock position at engine stopping or the like. This lock pin 24 is inserted into a lock hole (not shown) disposed in the housing 12, causing the displacement angle of the camshaft to be locked at a certain lock position. This lock position is set to a position suitable for engine startup (for example, substantially intermediate position within an adjustment possible range of a displacement angle of the cam shaft).

Oil inside an oil pan 26 (operating oil) is supplied to a hydraulic control circuit of the variable valve timing adjusting mechanism 11 through the hydraulic control valve 21 by an oil pump 27. The hydraulic control circuit includes a hydraulic supply oil passage 28 supplying oil discharged from an advance pressure port of the hydraulic control valve 21 to a plurality of advance hydraulic chambers 18 and a hydraulic supply oil passage 29 supplying oil discharged from a retard pressure port of the hydraulic control valve 21 to a plurality of retard hydraulic chambers 19.

Further, one-way valves 30 and 31 are disposed in the hydraulic supply oil passage 28 of the advance hydraulic chamber 18 and the hydraulic supply oil passage 29 of the retard hydraulic chamber 19 for preventing reverse flow of the operating oil from the respective chambers 18 and 19. In the present embodiment, the one-way valves 30 and 31 are disposed in the hydraulic control oil passages 28 and 29 of the advance hydraulic chamber 18 and the retard hydraulic chamber 19 in the single vane accommodating chamber 16 only.

The one-way valves 30 and 31 may be disposed in the hydraulic control oil passages 28 and 29 of the advance hydraulic chamber 18 and the retard hydraulic chamber 19 in each of a plurality of the vane accommodating chambers 16 without mentioning.

Drain oil passage 32 and 33 for bypassing the one-way valves 30 and 31 respectively are disposed in parallel in the hydraulic supply oil passages 28 and 29 of the respective chambers 18 and 19, and drain switching valves 34 and 35 are disposed in the drain oil passages 32 and 33 respectively. The drain switching valves 34 and 35 respectively are formed of spool valves driven in a closing direction by hydraulic pressure (pilot pressure) supplied from the hydraulic control valve 21. When the hydraulic pressure is not applied, the drain switching valves 34 and 35 are held in an opening position. When the drain switching valves 34 and 35 are opened, the drain oil passages 32 and 33 are opened, causing functions of the one-way valves 30 and 31 to be stopped. When the drain switching valves 34 and 35 are closed, the drain oil passages 32 and 33 are closed, causing functions of the one-way valves 30 and 31 to be effectively performed. Therefore, the reverse flow of the oil from the hydraulic chambers 18 and 19 is prevented, maintaining the hydraulic pressures in the hydraulic chambers 18 and 19.

The drain switching valves 34 and 35 respectively do not require electrical wiring and therefore, are downsized to be incorporated in the vane rotor 14 inside the variable valve timing adjusting mechanism 11, together with the one-way valves 30 and 31. In consequence, the drain switching valves 34 and 35 are located near the hydraulic chambers 18 and 19 respectively and are adapted to open/close the respective drain oil passages 32 and 33 near the respective hydraulic chambers 18 and 19 at advance/retard operating in good response.

On the other hand, the hydraulic control valve 21 is formed of a spool valve driven by a linear solenoid 36, where an advance/retard hydraulic control valve 37 controlling the hydraulic pressures supplied to the advance hydraulic chamber 18 and the retard hydraulic chamber 19 is integral with the a drain switching control valve 38 switching the hydraulic pressure driving the drain switching valves 34 and 35 respectively. A current value (control duty) supplied to the linear solenoid 36 of the hydraulic control valve 21 is controlled by an engine control circuit (hereinafter referred to as “ECU”) 43.

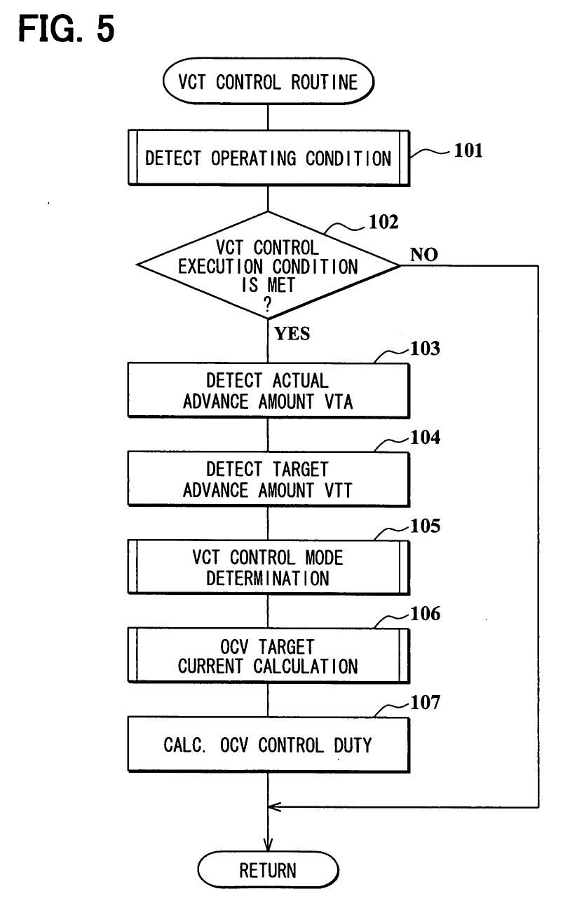

The ECU 43 calculates actual valve timing (actual displacement angle) of the intake valve (exhaust valve) based upon output signals of a crank angle sensor 44 and a cam angle sensor 45 and also calculates target valve timing (target displacement angle) of the intake valve (exhaust valve) based upon outputs of various sensors such as an intake pressure sensor and a water temperature sensor for detecting an engine operating condition. In addition, the ECU 43, according to execution of each routine in FIGS. 5 to 9 to be described later, controls a control current value of the hydraulic control valve 21 in the variable valve timing adjusting mechanism 11 so that the actual valve timing be equal to the target valve timing. Thereby, the hydraulic pressures in the advance hydraulic chamber 18 and the retard hydraulic chamber 19 are controlled to rotate the vane rotor 14 relative to the housing 12, causing a displacement angle of the cam shaft to be varied for making the actual valve timing be equal to the target valve timing.

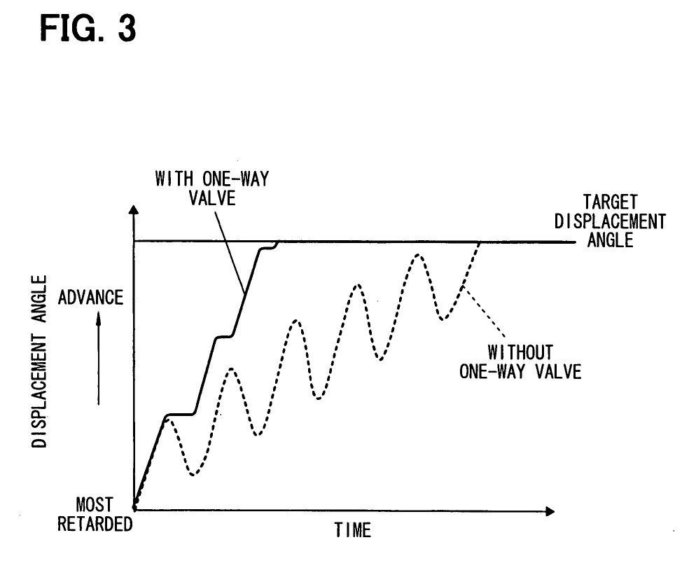

Here, when the intake valve or the exhaust valve is opened/closed during engine operating, the torque fluctuation the cam shaft receives from the intake valve or the exhaust valve is transmitted to the vane rotor 14, causing the torque fluctuation in the retard direction and in the advance direction to be exerted on the vane rotor 14. In consequence, when the vane rotor 14 is subjected to the torque fluctuation in the retard direction, the operating oil in the advance hydraulic chamber 18 receives the pressure to be pushed out of the advance hydraulic chamber 18 and on the other hand, when the vane rotor 14 is subjected to the torque fluctuation in the advance direction, the operating oil in the retard hydraulic chamber 19 receives the pressure to be pushed out of the retard hydraulic chamber 19. Therefore, in a low-rotation region where a discharge hydraulic pressure of the oil pump 27 as a hydraulic supply source is low, without the one-way valves 30 and 31, even if the hydraulic pressure is designed to be supplied to the advance hydraulic chamber 18 to advance a displacement angle of the cam shaft, as shown in a dotted line of FIG. 3, the vane rotor 14 is pushed back in the retard direction due to the torque fluctuation, raising the problem that the response time until the vane rotor 14 reaches a target displacement angle is longer.

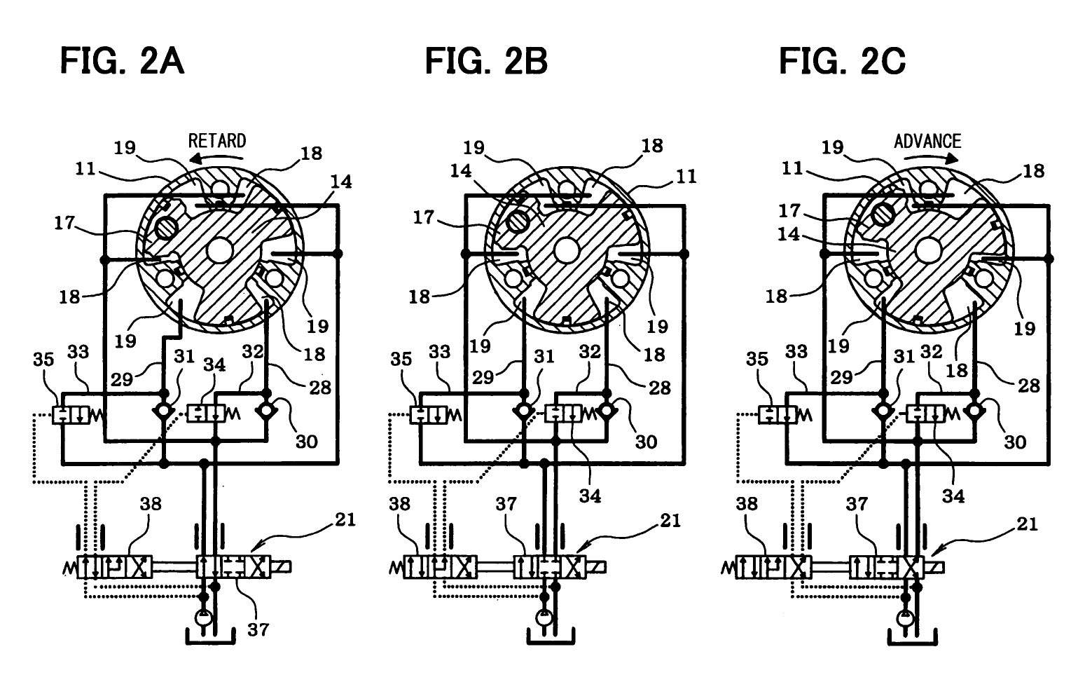

On the other hand, in the present embodiment, the one-way valves 30 and 31 are disposed in the hydraulic supply oil passage 28 of the advance hydraulic chamber 18 and the hydraulic supply oil passage 29 of the retard hydraulic chamber 19 for preventing reverse flow of the operating oil from the respective chambers 18 and 19. Further, the drain oil passage 32 and 33 for bypassing the one-way valves 30 and 31 respectively are disposed in parallel in the hydraulic supply oil passages 28 and 29 of the respective chambers 18 and 19, and drain switching valves 34 and 35 are disposed in the drain oil passages 32 and 33 respectively. As a result, as shown in FIGS. 2A, 2B and 2C, the hydraulic pressures in the chambers 18 and 19 respectively are controlled in response to a retard operation, a holding operation and an advance operation as follows.

### [Retard Operation]

As shown in FIG. 2A, during retard operating where the actual valve timing is retarded toward the target valve timing in the retard side, the hydraulic pressure is added to the drain switching valve 34 in the advance hydraulic chamber 18 from the hydraulic control valve 21 to open the drain switching valve 34 in the advance hydraulic chamber 18, creating the state where the one-way valve 30 in the advance hydraulic chamber 18 does not function. Further, the hydraulic supply to the drain switching valve 35 in the retard hydraulic chamber 19 is stopped to close the drain switching valve 35 in the retard hydraulic chamber 19, creating the state where the one-way valve 31 in the retard hydraulic chamber 19 functions. In consequence, even at a low hydraulic pressure, upon occurrence of the torque fluctuation in the advance direction of the vane rotor 14, the reverse flow of oil from retard hydraulic chamber 19 is prevented with the one-way valve 31, while efficiently supplying the hydraulic pressure to the retard hydraulic chamber 19, thereby to improve retard response characteristic.

### [Holding Operation]

As shown in FIG. 2B, during holding operating where the actual valve timing is held to the target valve timing, the hydraulic supply to both of the drain switching valves 34 and 35 in the advance hydraulic chamber 18 and in the retard hydraulic chamber 19 is stopped to close the drain switching valves 34 and 35, creating the state where the one-way valves 30 and 31 in the advance hydraulic chamber 18 and in the retard hydraulic chamber 19 function. In this state, even if the torque fluctuations in the retard direction and in the advance direction are applied to the vane rotor 14 due to the torque fluctuations the cam shaft receives from the intake valve or the exhaust valve, the reverse flow of oil from both of the advance hydraulic chamber 18 and the retard hydraulic chamber 19 is prevented with the one-way valve 31 to prevent reduction in the hydraulic pressures holding the vane 17 from both side thereof, thereby to improve holding stability.

Further, in the present embodiment, even during holding operating, the control current of the hydraulic control valve 21 is feedback-controlled in accordance with a deviation between the target displacement angle (target advance amount) and the actual displacement angle (actual advance amount). In consequence, it is prevented that the actual displacement angle (actual advance amount) deviates from the target displacement angle (target advance amount), enabling further improvement on holding stability.

### [Advance Operation]

As shown in FIG. 2C, during advance operating where the actual valve timing is advanced toward the target valve timing in the advance side, the hydraulic pressure supply to the drain switching valve 34 in the advance hydraulic chamber 18 is stopped to close the drain switching valve 34 in the advance hydraulic chamber 18, causing the state where the one-way valve 30 in the advance hydraulic chamber 18 functions. Further, the hydraulic pressure from the hydraulic control valve 21 is applied to the drain switching valve 35 in the retard hydraulic chamber 19 is added to open the drain switching valve 35 in the retard hydraulic chamber 19, creating the state where the one-way valve 31 in the retard hydraulic chamber 19 does not function. In consequence, even at a low hydraulic pressure, the reverse flow of oil from the advance hydraulic chamber 18 upon occurrence of the torque fluctuation in the retard direction of the vane rotor 14 is prevented with the one-way valve 30, while efficiently supplying the hydraulic pressure to the advance hydraulic chamber 18, thereby to improve advance response characteristic.

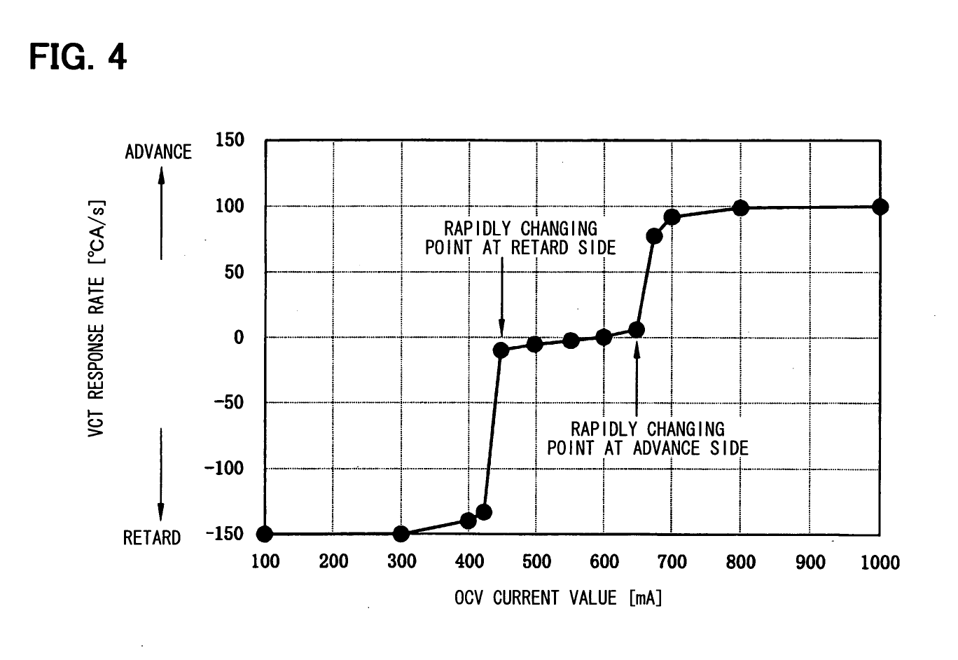

Next, the response characteristic of the variable valve timing adjusting mechanism 11 (hereinafter referred to as “VTC response characteristic”) will be explained with reference to FIG. 4. FIG. 4 shows one example of a response characteristic obtained by measuring a relation between a control current value of the hydraulic control valve 21 (hereinafter, referred to as “OCV current value”) and a response rate of the variable valve timing adjusting mechanism 11.

In the present embodiment, since the one-way valves 30 and 31 and the drain switching valves 34 and 35 are disposed in both of the advance hydraulic chamber 18 and the retard hydraulic chamber 19, a VTC response rate does not change linearly to a change of an OCV current value and opening/closing of the drain switching valves 34 and 35 is switched, causing the VTC rate to rapidly change at two locations. In the VTC response characteristic of FIG. 4, the rapidly changing point of the VTC response rate at the retard side is a point where the drain switching valve 34 in the advance hydraulic chamber 18 switches from closing state to opening state, and the rapidly changing point of the VTC response rate at the advance side is a point where the drain switching valve 35 in the retard hydraulic chamber 19 switches from closing state to opening state. The holding operation is made in a region where a grade of a VTC response rate change between the rapidly changing point of the VTC response rate at the retard side and the rapidly changing point of the VTC response rate at the advance side is small.

The conventional VTC where the one-way valves 30 and 31 and the drain switching valves 34 and 35 are not provided performs control of increasing a feedback gain at a transient time of the variable valve timing control in order to enhance a response characteristic at the transient time. However, when the feedback gain is excessively increased, the overshooting occurs to deteriorate a convergent characteristic of an actual displacement angle to a target displacement angle, thereby producing the problem of deteriorating combustion of an engine or the like.

In contrast, as in the case of the present embodiment, in the VTC 11 of disposing the one-way valves 30 and 31, as well as disposing the drain switching valves 34 and 35, when the drain switching valves 34 or 35 at the side of the hydraulic chamber where the operating oil is discharged is closed during a variable operation (advance/retard operation) of the VTC 11, the discharge of the operating oil is stopped at this point to stop the variable operation of the VTC 11. As a result of using this dynamic characteristic, even when the VTC 11 is driven at the maximum speed, it is possible to rapidly stop the variable operation of the VTC 11.

In view of this respect, the present embodiment is structured in such a manner that when a deviation between the target displacement angle and the actual displacement angle is more than a determination threshold value, the drain switching valve at the side of the hydraulic chamber where oil is discharged is opened to control the hydraulic control valve at a maximum speed control to perform “maximum speed control” of driving the VTC 11 in a direction of the target displacement angle at a maximum speed or at a high speed close thereto, and when the deviation between the target displacement angle and the actual displacement angle becomes smaller, the drain switching valve at the side of the hydraulic chamber where the oil is discharged is closed to switch to “holding control” for stopping a variable operation of the VTC 11 or slowing a speed thereof. In addition, during this holding operating, the OCV current is feedback-controlled by PD control or the like so that the deviation between the target displacement angle and the actual displacement angle is small in a state where the drain switching valves 34 and 35 in both sides of the advance hydraulic chamber 18 and the retard hydraulic chamber 19 are closed, thus preventing deviation of the actual displacement angle from the target displacement angle and further improving a holding stability.

In this case, timing switching from the maximum speed control to the holding control is set based upon an estimation value of a VTC displacement amount from a point when the VTC control mode is switched to the holding control until a point when the variable operation of the VTC 11 is actually stopped so that the actual displacement angle securely stops at the target displacement angle.

In addition, the VTC displacement amount from a point when the VTC control mode is switched to the holding control until a point when the variable operation of the VTC 11 is actually stopped is estimated based upon a VTC variable speed (maximum speed) and a valve-closing response rate of the drain switching valves 34 and 35 during the maximum speed controlling. In this case, the maximum speed (VTC variable speed during the maximum speed controlling) and the valve-closing response rate of the drain switching valves 34 and 35 may use a predetermined value (for example, a design value or the like), but in consideration of variations in VTC variable speed due to manufacturing variations or an aging change of the VTC 11, the present embodiment detects a changing speed of the actual displacement angle during the maximum speed controlling to estimate the maximum speed based upon the detection value.

Alternatively, the maximum speed and the valve-closing response rate of the drain switching valves 34 and 35 may be estimated based upon a pressure and a temperature of oil supplied to the VTC 11 or information correlating to those. This is because of consideration of the characteristic that as the hydraulic pressure is smaller, the maximum speed is lower, and as the oil temperature is lower, the viscosity resistance of the oil is larger to reduce the maximum speed. In general, since an oil pump 26 supplying hydraulic pressure to the VTC 11 is driven by power of the engine, there is a relation that as an engine rotational speed increases, the hydraulic pressure is higher. Accordingly an engine rotational speed may be used as alternative information of the hydraulic pressure. Further, since there is a correlation between an oil temperature and an engine temperature, an engine temperature (cooling water temperature) may be used as alternative information of the oil temperature.

The VTC control of the present embodiment explained above is performed according to each routine in FIGS. 5 to 9 by the ECU 43. Hereinafter, the process content of each routine will be explained.

### [VTC Control Routine]

A VTC control routine in FIG. 5 is executed in a predetermined cycle (for example, 5 ms cycle) during engine operating. When the present routine is activated, first at step S101 an operating condition (for example, engine rotational speed, load, cooling water temperature or the like) is detected. At next step S102 it is determined whether or not a VTC control execution condition is met based upon the detected operating condition. As a result, when it is determined that the VTC control execution condition is not met, the present routine ends without execution of the subsequent process. In a case where the VTC control is not performed, a target advance amount VVT is maintained to zero (maximum retard position).

On the other hand, when it is determined at step S102 that the VTC control execution condition is met, the process goes to step S103, wherein an actual advance amount VTA (advance amount from the maximum retard amount to the present position) is calculated based upon a phase difference between an output signal of a crank angle sensor 44 and an output signal of a cam angle sensor 45 occurring following it. At next step S104 a target advance amount VTT is calculated from a map or the like in accordance with the present operating condition (engine rotational speed, load or the like).

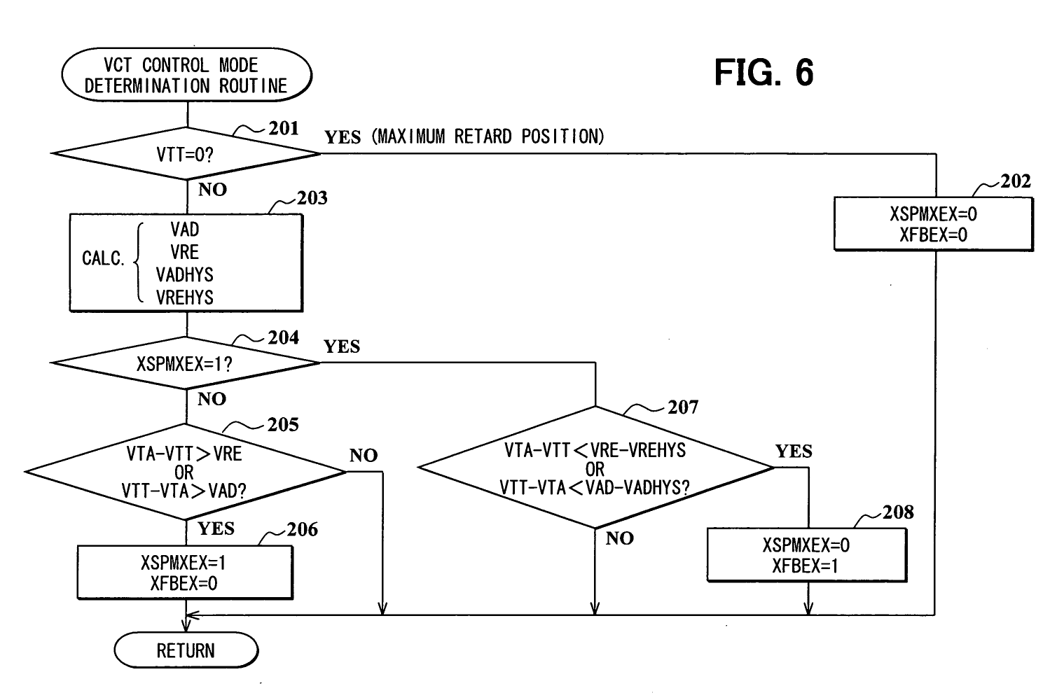

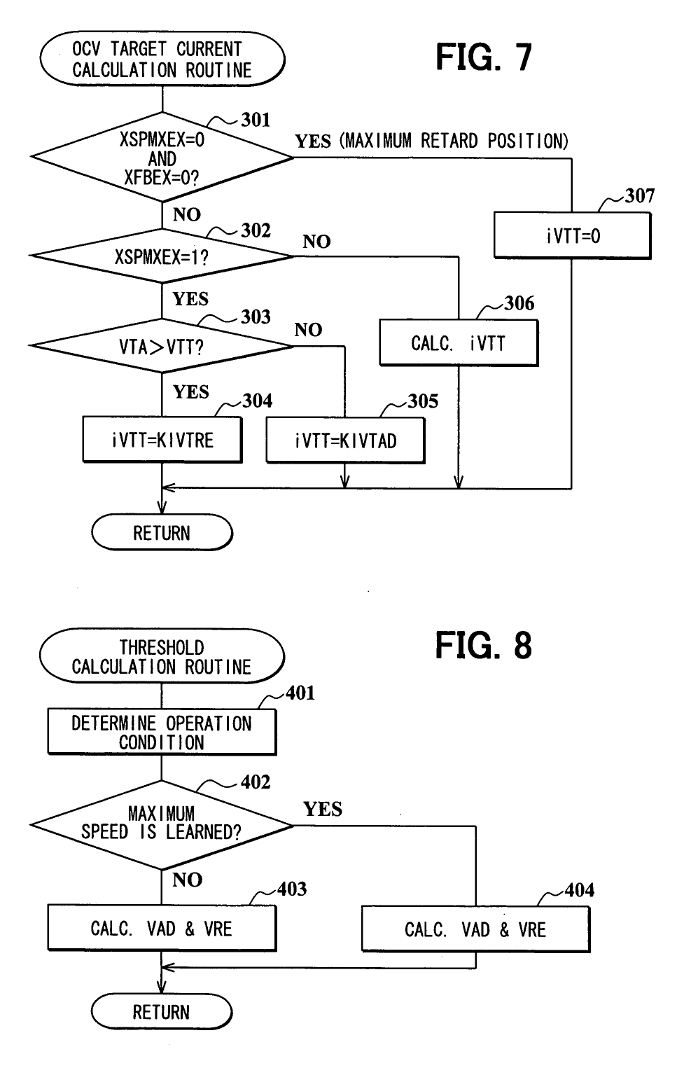

Thereafter, the process goes to step S105, wherein a VTC control mode determination routine in FIG. 6 to be described later is executed to determine whether the present VTC control mode is the maximum speed control mode or the holding control mode (feedback control mode). After this, the process goes to step S106, wherein an OCV target current calculation routine in FIG. 7 to be described later is executed to calculate an OCV target current iVVT in accordance with the present VTC control mode. In addition, at next step S107 a control duty is calculated for controlling a control current of the hydraulic control valve 21 (OCV) to the OCV target current iVVT, and the present routine ends.

### [VTC Control Mode Determination Routine]

A VTC control mode determination routine in FIG. 6 is a subroutine executed at step S105 of the VTC control routine in FIG. 5. When the present routine is activated, first at step S201 it is determined whether or not a target advance amount VTT is zero (maximum retard position). When the target advance amount VTT is zero (maximum retard position), it is determined that the VTC control (maximum speed control and holding control) is not performed and the process goes to step S202, wherein a maximum speed control execution flag XSPMXEX and a holding control execution flag XFBEX are cleared to zero and the present routine ends.

On the other hand, when it is determined at step S201 that the target advance amount VTT is not zero (maximum retard position), the process goes to step S203, wherein a control switching determination threshold value calculation routine in FIG. 8 to be described later is executed, thereby calculating a determination threshold value (advance side determination threshold value VAD, retard side determination threshold value VRE) and a hysteresis value (advance side hysteresis value VADHYS, retard side hysteresis value VREHYS) for determining timing for switching the maximum speed control and the holding control.

Here, an advance side/retard side determination threshold value VAD, VRE is a determination threshold value for switching from holding control to maximum speed control when a deviation between a target advance amount VTT and an actual advance amount VTA is greater than any of the advance side/retard side determination threshold value VAD, VRE. Further, the advance side hysteresis value VADHYS/retard side hysteresis value VREHYS is used as a correction value to the advance side/retard side determination threshold value VAD, VRE for creating hysteresis for a switching characteristic between maximum speed control and holding control. Each hysteresis value VADHYS, VREHYS may be a predetermined value (for example, design value or the like) or may be a predetermined ratio (for example, 10%) of each determination threshold value VAD, VRE.

Each determination threshold value VAD, VRE and each hysteresis value VADHYS, VREHYS respectively are estimated based upon a VTC variable speed (maximum speed) during maximum speed controlling and a valve-closing response rate of the drain switching valves 34 and 35. In other words, as the VTC variable speed (maximum speed) during maximum speed controlling becomes larger, a VTC displacement amount (advance/retard amount) from a point when the VTC control mode is switched to the holding control until a point when a variable operation of the VTC actually stops increases. Further, as the valve-closing response rate of the drain switching valves 34 and 35 become slower, a VTC displacement amount until the variable operation of the VTC actually stops increases. In consequence, when each determination threshold value VAD, VRE and each hysteresis value VADHYS, VREHYS for determining timing of switching the maximum speed control and the holding control are set based upon the maximum speed (VTC variable speed during maximum speed controlling) and the valve-closing response rate of the drain switching valve, they can be set to appropriate values.

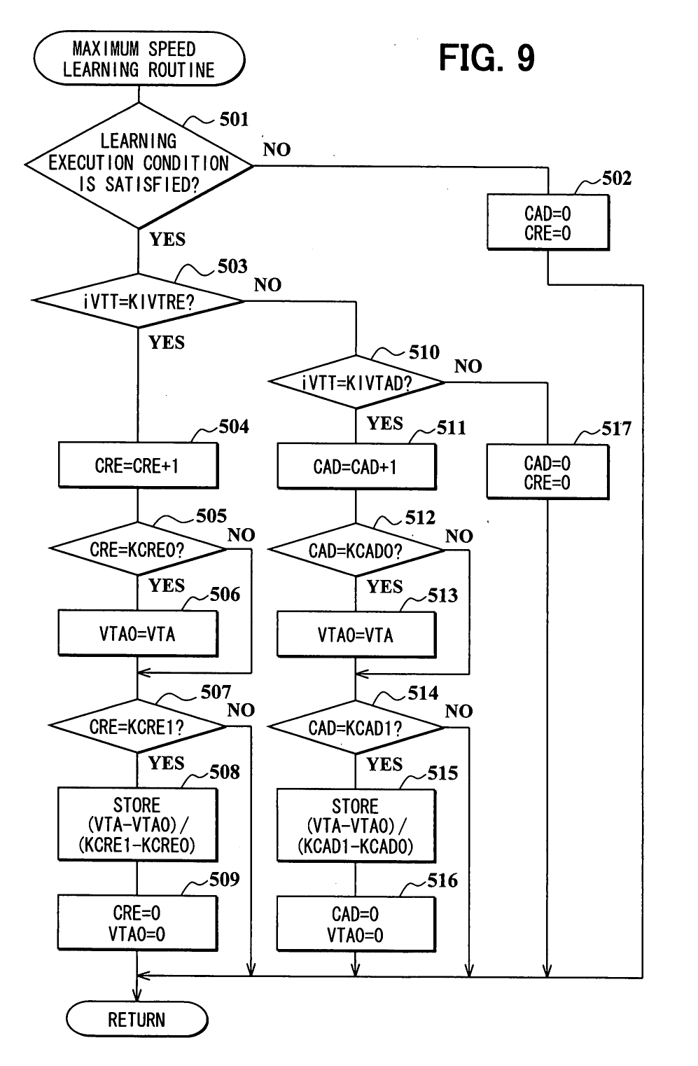

In this case, the maximum speed and the valve-closing response rate of the drain switching valves 34 and 35 may use a predetermined value (for example, a design value or the like), but in consideration of variations in VTC variable speed due to manufacturing variations or an aging change of the VTC 11, the present embodiment detects a changing speed of the actual displacement angle during the maximum speed controlling by a maximum speed learning routine in FIG. 9 to be described later to learn the maximum speed based upon the detection value. It should be noted that the present embodiment learns the maximum speed for each operating condition (for example, engine rotational speed region) to use the learned value of the maximum speed in accordance with the present operating condition.

In addition, since the maximum speed and the valve-closing response rate of the drain switching valves 34 and 35 change by a main cause such as a pressure or viscosity (oil temperature) of oil supplied to the VTC 11, a map of maximum speeds or valve-closing response rates using oil pressures and oil temperatures or information correlating to those as parameters may be produced to estimate maximum speeds or valve-closing response rates of the drain switching valves 34 and 35 from the map. Here, an engine rotational speed may be used as alternative information of a hydraulic pressure or a cooling water temperature may be used as alternative information of oil temperature.

After that, the process goes to step S204, wherein it is determined whether or not the maximum speed control execution flag XSPMXEX is set to “1”, which means “in the middle of executing the maximum speed control”. When the maximum speed control execution flag XSPMXEX is set to “0”, it is determined that the valve timing control is in the middle of executing the holding control at present and the process goes to step S205, wherein it is determined whether or not a deviation between a target advance amount VTT and an actual advance amount VTA is greater than any of the advance side/retard side determination threshold value VAD, VRE. As a result, when it is determined that the deviation between the target advance amount VTT and the actual advance amount VTA is less than any of the advance side/retard side determination threshold value VAD, VRE, the present routine ends to continue the holding control.

On the other hand, when it is determined at step S205 that the deviation between the target advance amount VTT and the actual advance amount VTA is greater than any of the advance side/retard side determination threshold value VAD, VRE, the process goes to step S206, wherein the maximum speed control execution flag XSPMXEX is set to “1”, and the holding control execution flag XFBEX is cleared to “0” to switch the VTC control mode from the holding control to the maximum speed control.

On the other hand, when it is determined at step S204 that the maximum speed control execution flag XSPMXEX is set to “1”, it is determined that the VTC control mode is in the middle of executing the maximum speed control at present and the process goes to step S207, wherein it is determined whether or not a deviation between a target advance amount VTT and an actual advance amount VTA is smaller than any of an advance side/retard side determination threshold value VAD-VADHYS, VRE-VREHYS. As a result, when it is determined that the deviation between the target advance amount VTT and the actual advance amount VTA is more than any of the advance side/retard side determination threshold value VAD-VADHYS, VRE-VREHYS, the present routine ends as it is to continue the maximum speed control.

On the other hand, when it is determined at step S207 that the deviation between the target advance amount VTT and the actual advance amount VTA is smaller than any of the advance side/retard side determination threshold value VAD-VADHYS, VRE-VREHYS, the process goes to step S208, wherein the maximum speed control execution flag XSPMXEX is cleared to “0”, and the holding control execution flag XFBEX is set to “1” to switch the VTC control mode from the maximum speed control to the holding control.

In this case, the determination threshold values VAD-VADHYS, VRE-VREHYS for determining timing for switching from the maximum speed control to the holding control are set based upon an estimation value of the VTC displacement amount from a point when the VTC control mode is switched to the holding control to a point when the variable operation of the VTC actually stops so that the actual advance amount of the VTC securely stops at the target advance amount.

### [OCV Target Current Calculation Routine]

An OCV target current calculation routine in FIG. 7 is a subroutine executed at step S106 of the VTC control routine in FIG. 5. When the present routine is activated, first at step S301 it is determined whether or not the maximum speed control execution flag XSPMXEX and the holding control execution flag XFBEX both are “0”. When the maximum speed control execution flag XSPMXEX and the holding control execution flag XFBEX both are “0”, it is determined that the VTC control (maximum speed control and holding control) is not performed and the process goes to step S307, wherein the OCV target current iVVT is maintained to zero (maximum retard position). It should be noted that the OCV target current iVVT at the maximum retard position may be a current value other than zero so long as the VTC does not advance with the current.

On the other hand, when any of the maximum speed control execution flag XSPMXEX and the holding control execution flag XFBEX both is set to “1”, at step S301 the determination result is “No”, and the process goes to step S302, wherein it is determined whether or not the maximum speed control execution flag XSPMXEX is set to “1”, which means “in the middle of executing the maximum speed control”. When the maximum speed control execution flag XSPMXEX is set to “1”, it is determined that the VTC timing control mode is in the middle of executing the maximum speed control at present and the process goes to step S303, wherein a driving direction of the VTC 11 is determined depending on a difference in a magnitude between the actual advance amount VTA and the target advance amount VTT. When the actual advance amount VTA is greater than the target advance amount VTT at this point, it is determined that the VTC is driven in the retard direction and the process goes to step S304, wherein the OCV target current iVVT at the maximum speed control is set to a retard side critical current value KIVTRE (0 mA) to drive the VTC in the retard direction at the maximum speed.

On the other hand, when the actual advance amount VTA is smaller than the target advance amount VTT, it is determined that the VTC is driven in the advance direction and the process goes to step S305, wherein the OCV target current iVVT at the maximum speed control is set to an advance side critical current value KIVTAD (OCV maximum tolerance current) to drive the VTC in the advance direction at the maximum speed.

In addition, when it is determined at step S302 that the maximum speed control execution flag XSPMXEX is set to “0”, it is determined that the VTC timing control mode is in the middle of executing the holding control at present and the process goes to step S306, wherein the OCV target current iVVT is calculated by feedback control such as PD control in accordance with a deviation between the actual advance amount VTA and the target advance amount VTT in the middle of executing the holding control.

On this occasion, at a point of switching the VTC control mode from the maximum speed control to the holding control, the OCV target current iVVT is switched from the retard side critical current value KIVTRE or the advance side critical current value KIVTAD of the maximum speed to the holding current learning value (that is, an initial value of the OCV target current iVVT of the holding control is set as the holding current learning value). During the holding controlling, a current value obtained by adding a feedback correction amount in accordance with the deviation between the actual advance amount VTA and the target advance amount VTT to the holding current learning value is set to the OCV target current iVVT of the holding control.

As for the learning of the holding current, an OCV current when the actual advance amount VTA is maintained to a state of being equal to the target advance amount VTT during the holding controlling is learned as the holding current and this learned holding current may be stored as update in a rewritable, involatile memory in the ECU 43. This learning value of the holding current may be learned at each region of the target advance amount VTT or at each operating condition (each engine rotational region or the like), or one holding current which is in common in all operating conditions may be learned.

### [Control Switching Determination Threshold Value Calculation Routine]

A control switching determination threshold value calculation routine in FIG. 8 is a subroutine executed at step S203 of the VTC control mode determination routine in FIG. 6. When the present routine is activated, first at step S401 the present operation condition is determined by detecting an engine rotational speed, an oil temperature (or cooling water temperature) or the like. Thereafter, the process goes to step S402, wherein it is determined whether or not the maximum speed is learned on the same condition with the present operating condition. When the maximum speed is not learned yet, the process goes to step S403, wherein a maximum speed and a valve-closing response rate of the drain switching valves 34 and 35 are calculated form a map in accordance with the present operating condition and the advance side/retard side determination threshold value VAD, VRE is calculated from a map in accordance with the maximum speed and the valve-closing response rate of the drain switching valves 34 and 35.

On the other hand, when it is determined at step S402 that the maximum speed is learned on the same condition with the present operating condition, the process goes to step S404, wherein a learning value of the maximum speed learned on the same condition with the present operating condition is retrieved among the learning value of the maximum speed for each operating condition stored in a rewritable, involatile memory such as a backup RAM of the ECU 43 or the like. The advance side/retard side determination threshold value VAD, VRE is calculated from a map in accordance with the learning value of the maximum speed and the valve-closing response rate of the drain switching valves 34 and 35.

It should be noted that the advance side/retard side hysteresis value VADHYS, VREHYS may be a predetermined value (for example, a design value or the like) or a predetermined ratio (for example, 10%) of the determination threshold value VAD, VRE.

### [Maximum Speed Learning Routine]

A maximum speed learning routine in FIG. 9 is executed in a predetermined cycle during engine operating. When the present routine is activated, first at step S501 it is determined whether or not the maximum speed learning execution condition meets the following two conditions (1) and (2) both.

(1) A changing amount Δne of an engine rotational speed is more than a predetermined value KPNE (Δne≧KPNE).

(2) An actual advance amount VTA is within a predetermined range (KVTHRE≦VTA≦KVTHAD).

Here, the above condition is because when the changing amount Δne of the engine rotational speed is small, as the VTC 11 is driven at the maximum speed, it possibly raises the problem with combustion deterioration or the like.

In addition, the above condition (2) is because when the actual advance amount VTA is in a region close to the maximum retard position or the maximum advance position, there is no freedom degree of driving the VTC 11 in the retard or advance direction at the maximum speed.

When any of the above conditions (1) and (2) is not met, the maximum speed learning execution condition is not met and the process goes to step S502, wherein an advance direction maximum speed control time counter CAD and a retard direction maximum speed control time counter CRE both are cleared to zero and the present routine ends.

In contrast, when both of the above conditions (1) and (2) are met, it is determined that the maximum speed learning execution condition is met and the process goes to step S503, wherein it is determined whether or not the OCV target current iVVT is the retard side critical current value KIVTRE (0 mA). As a result, when it is determined that the OCV target current iVVT is the retard side critical current value KIVTRE (0 mA), it is determined that the VTC is driven in the retard direction at the maximum speed and the process goes step S504, wherein the retard direction maximum speed control time counter CRE is incremented by “1” to measure the maximum speed control time in the retard direction. At next step S505 it is determined whether or not the maximum speed control time in the retard direction measured at the retard direction maximum speed control time counter CRE has reached a first predetermined time KCRE0. In addition, at a point when the maximum speed control time in the retard direction has reached the first predetermined time KCRE0, the process goes to step S506, wherein the actual advance amount VTA at this point is stored as “VTA0” in a RAM of the ECU 43.

After that, the process goes to step S507, wherein it is determined whether or not the maximum speed control time in the retard direction measured at the retard direction maximum speed control time counter CRE has reached a second predetermined time KCRE1. In addition, at a point when the maximum speed control time in the retard direction has reached the second predetermined time KCRE1, the process goes to step S508, wherein the actual advance amount VTA at this point and the actual advance amount VTA0 stored in a certain time before this point (KCRE1−KCRE0) are used to calculate an average retard speed for a predetermined period (CRE=KCRE0 to KCRE1) during the maximum speed controlling in the retard direction as “the maximum speed in the retard direction”.

Maximum speed in the retard direction=(VTA−VTA0)/(KCRE1−KCRE0).

The maximum speed in the retard direction calculated by the above equation is updated/stored in a rewritable, involatile memory of the ECU 43 for each operating condition. After that, the process goes to step S509, wherein the retard direction maximum speed control time counter CRE is cleared and the memory value of the past actual advance amount VTA0 is cleared to end the present routine.

On the other hand, when it is determined at step S503 that the OCV target current iVVT is not the retard side critical current value KIVTRE (0 mA), the process goes to step S510, wherein it is determined whether or not the OCV target current iVVT is an advance side critical current value KIVTAD (OCV maximum tolerance current). As a result, when it is determined that the OCV target current iVVT is the advance side critical current value KIVTAD, it is determined that the VTC 11 is driven in the advance direction at the maximum speed and the process goes step S511, wherein the advance direction maximum speed control time counter CAD is incremented by one by one to measure the maximum speed control time in the advance direction. At next step S512 it is determined whether or not the maximum speed control time in the advance direction measured at the advance direction maximum speed control time counter CAD has reached a first predetermined time KCAD0. In addition, at a point when the maximum speed control time in the advance direction has reached the first predetermined time KCAD0, the process goes to step S513, wherein the actual advance amount VTA at this point is stored as “VTA0” in the RAM of the ECU 43.

After that, the process goes to step S514, wherein it is determined whether or not the maximum speed control time in the advance direction measured at the advance direction maximum speed control time counter CAD has reached a second predetermined time KCAD1. In addition, at a point when the maximum speed control time in the advance direction has reached the second predetermined time KCAD1, the process goes to step S515, wherein the actual advance amount VTA at this point and the actual advance amount VTA0 stored in a certain time before this point (KCAD1−KCAD0) are used to calculate an average advance speed for a predetermined period (CAD=KCAD0 to KCAD1) during the maximum speed controlling in the advance direction as “the maximum speed in the advance direction”.

Maximum speed in the advance direction=(VTA−VTA0)/(KCAD1−KCAD0).

The maximum speed in the advance direction calculated by the above equation is updated/stored in a rewritable, involatile memory of the ECU 43 for each operating condition. After that, the process goes to step S516, wherein the advance direction maximum speed control time counter CAD is cleared and the memory value of the past actual advance amount VTA0 is cleared to end the present routine.

It should be noted that when the determination result is “No” at step S503 and at step S510 respectively, it is determined that the present VTC control mode is not the maximum speed and the process goes to step S517, wherein the advance direction maximum speed control time counter CAD and the retard direction maximum speed control time counter CRE both are cleared to zero to end the present routine.

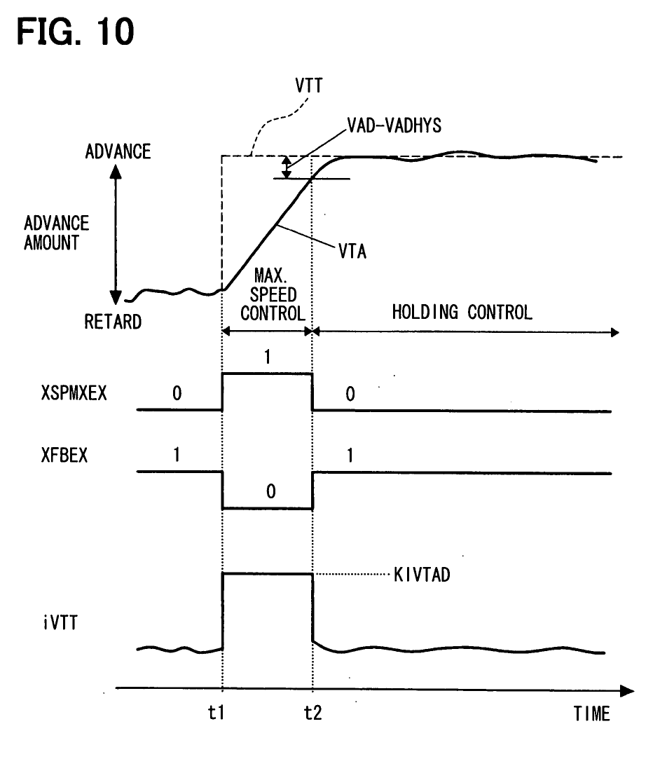

An example of the VTC control in the present embodiment explained above will be explained using a time chart in FIG. 10. In a control example in FIG. 10, a target advance amount VTT is largely changed stepwise in the middle of executing the holding control for feedback-controlling an actual advance amount close to the target advance amount VTT. At time t1 when a deviation between the target advance amount and the actual advance amount (VVT−VTA) exceeds an advance side determination threshold value VAD, the maximum speed control execution flag XSOMXEX is set to “1” to switch the VTC control mode from holding control to maximum speed control. During the maximum speed controlling in the advance direction, the drain switching valve 35 of the retard hydraulic chamber 19 is opened to facilitate the oil discharge from the retard hydraulic chamber 19 and an OCV target current iVVT is set to an advance side critical current value KIVTAD (OCV maximum tolerance current) to drive the VTC in the advance direction at the maximum speed.

At time t2 when the deviation between the target advance amount and the actual advance amount (VVT−VTA) becomes smaller than the advance side determination threshold value VAD-VADHYS by this maximum speed control, the holding control execution flag XFBEX is set to “1” to switch the VTC control mode from maximum speed control to holding control. At time t2, the drain switching valve 35 of the retard hydraulic chamber 19 is closed to stop discharge of the oil from the retard hydraulic chamber 19, thus rapidly stopping the advance operation of the VTC 11 from the maximum speed.

At time t2 when the VTC control mode is switched from maximum speed control to the holding control, the OCV target current iVVT is switched from the advance side critical current value KIVTAD to the holding current learning value. During the holding controlling, a current value obtained by adding a feedback correction amount in accordance with the deviation between the actual advance amount VTA and the target advance amount VTT to the holding current learning value is set to the OCV target current iVVT of the holding control, maintaining the actual advance amount VTA close to the target advance amount VTT.

In the present embodiment explained above, when the deviation between the target advance amount and the actual advance amount (VVT−VTA) exceeds the determination threshold value VAD, VRE, the drain switching valve of the side of the hydraulic chamber where the oil is discharged is opened to perform the maximum speed control for driving the VTC 11 in the direction of the target advance amount VTT at the maximum speed. When the deviation between the target advance amount and the actual advance amount (VVT−VTA) becomes smaller than the determination threshold value VAD-VADHYS, VRE-VREHYS, the drain switching valve of the side of the hydraulic chamber where the oil is discharged is closed to switch to the holding control for stopping or slowing the variable operation of the VTC 11. In consequence, the VTT 11 is driven in the direction of the target advance amount VTT at the maximum speed until the actual advance amount VTA comes close to the target advance amount VTT to close the drain switching valve immediately before reaching to the target advance amount VTT, thus rapidly stopping the variable operation of the VCT 11. Therefore, the response characteristic of the VTC control can be largely improved without occurrence of the overshooting.

It should be noted that in the present embodiment, the VTC 11 is driven at the maximum speed during the maximum speed controlling, but may be driven at a high speed close to the maximum speed without mentioning.

In addition, in the present embodiment, the deviation between the target advance amount VVT and the actual advance amount VTA is compared with the determination threshold value to determine switching timing between the maximum speed control and the holding control, but a displacement amount of the VTC until the variable operation of the VTC 11 actually stops after the VTC control mode is switched from maximum speed control to holding control may be estimated to switch the VTC control mode from maximum speed control to holding control when the deviation between the target displacement angle and the actual displacement angle is equal to the estimation value of the VTC displacement amount. In this way, the switching timing can be set so that the actual advance amount of the VTC 11 securely stops at the target advance amount VTT, thus enabling an improvement on a convergent characteristic of the actual advance amount VTA to the target advance amount VTT.

In this case, the VTC displacement amount from a point when the VTC control mode switched to the holding control to a point when the VTC control mode stops may be in advance set by a map or the like in accordance with a maximum speed, an operating condition or the like, but the VTC displacement amount to a point when the VTC control mode stops may be estimated by using a model simulating a hydraulic response delay of a variable operation of the VTC 11. In this way, since it is not required to store a map of the VTC displacement amount or the like, it has an advantage of saving a memory of the ECU 43 by a magnitude corresponding to it.

It should be noted that in the present invention, the hydraulic switching valve 38 for switching the hydraulic pressure driving the drain switching valves 34 and 35 may be separated from the hydraulic control valve 21, but since in the present embodiment, the hydraulic switching valve 38 is integral with the hydraulic control valve 21, it has an advantage of being capable of satisfying requirements of reduction of the number of component parts, costs and downsizing.

Besides, the present invention can be carried out with various modifications within the spirit thereof, such as a proper modification of a structure of the variable valve timing adjusting mechanism 11.

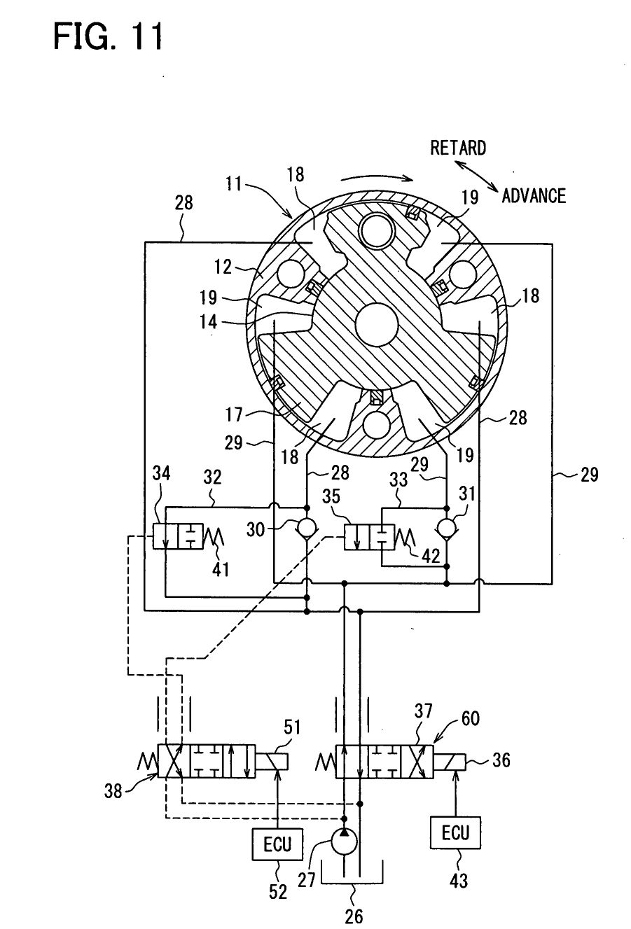

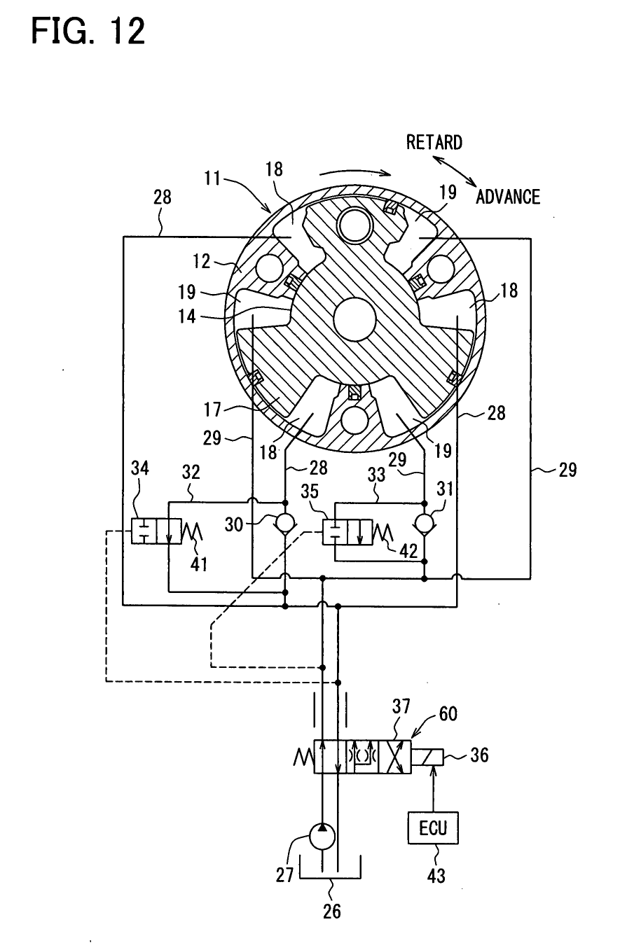

For example, in the above embodiment, the present invention is applied to the variable valve timing adjusting mechanism 11 shown in FIG. 1, but, not limited thereto, may be applied to a variable valve timing adjusting mechanism shown in FIG. 11 or 12, for example.

Components in FIGS. 11 and 12 identical to those in FIG. 1 are referred to like numbers.

First, the hydraulic control valve 21 in FIG. 1 drives the advance/retard hydraulic control valve 37 and the drain switching valve 38 by a single linear solenoid 36, but in a variable valve adjusting mechanism shown in FIG. 11, solenoids 36 and 51 are disposed in the advance/retard hydraulic control valve 37 and the drain switching valve 38 respectively and are respectively controlled by each of the ECUs 43 and 52.

The drain switching valves 34 and 35 shown in FIG. 1 are normally open-type switching valves, which are held in an open position by springs 41 and 42 when the hydraulic pressure is not applied to the drain switching valves 34 and 35. In contrast, in FIG. 11, when the hydraulic pressure is not applied to the drain switching valves 34 and 35, normally closed-type switching valves held in a closed open position by springs 41 and 42 are used as the drain switching valves 34 and 35. In consequence, the drain switching control function 38 is structured to supply the hydraulic pressure at the time of closing the drain switching valve, but in FIG. 11, is structured to stop the hydraulic pressure supply at the time of closing the drain switching valve.

In addition, in FIG. 1, the one-way valve and the drain switching valve are disposed in the hydraulic pressure supply passages corresponding to the advance hydraulic chamber and the retard hydraulic chamber in the single vane-accommodating chamber defined by a single vane, but in FIG. 11, the one-way valve and the drain switching valve are disposed in the hydraulic pressure supply passage corresponding to the advance hydraulic chamber in one vane-accommodating chamber and also in the hydraulic pressure supply passage corresponding to the retard hydraulic chamber in the other vane-accommodating chamber.

The present invention may be applied to the variable valve adjusting timing mechanism shown in FIG. 11 as described above.

In contrast, in FIG. 12, a single valve achieves an advance/retard hydraulic control function and a drain switching control function. For this reason, the hydraulic pressure supply passages 28 and 29 are branched between the hydraulic control valve and the one-way valve and are in communication with the drain switching valves 34 and 35 respectively.

What is claimed is:

1. A controller for a vane-type variable valve timing adjusting mechanism in which each of a plurality of vane accommodating chambers formed in a housing is divided into an advance hydraulic chamber and a retard hydraulic chamber by a vane,
the variable valve timing adjusting mechanism being provided with a one-way valve in a hydraulic supply passage of the advance hydraulic chamber and a hydraulic supply passage of the retard hydraulic chamber in at least one of the vane accommodating chambers for preventing reverse flow of operating oil from the each hydraulic chamber,
the variable valve timing adjusting mechanism being provided with a drain oil passage in parallel to the hydraulic supply passage of the each hydraulic chamber for bypassing the one-way valve, a drain switching valve in the each drain oil passage and driven by a hydraulic pressure, and a hydraulic switching valve switching the hydraulic pressure driving the each drain switching valve, the controller comprising:
a control means for controlling the hydraulic control valve to vary a hydraulic pressure in the each hydraulic chamber so that an actual displacement angle of the variable valve timing adjusting mechanism is equal to a target displacement angle and for opening/closing the drain switching valve of the each hydraulic chamber by controlling the hydraulic switching valve, wherein:
when a deviation between the target displacement angle and the actual displacement angle is not less than a predetermined value, the control means performs a maximum speed control of the hydraulic control valve to open the drain switching valve communicating with the hydraulic chamber where the operating oil is discharged in such a manner as to drive the variable valve timing adjusting mechanism in a direction of the target displacement angle at a maximum speed or at a high speed close thereto, and
when the deviation between the target displacement angle and the actual displacement angle is less than the predetermined value, the control means performs a holding control of the hydraulic control valve to close the drain switching valve communicating with the hydraulic chamber where the operating oil is discharged in such a manner as to stop a variable operation of the variable valve timing adjusting mechanism or decrease an operation speed thereof.

2. A controller for a vane-type variable valve timing adjusting mechanism according to claim 1, wherein:
the control means sets a determination threshold value of the deviation between the target displacement angle and the actual displacement angle for determining a switching timing from the maximum speed control to the holding control based upon the maximum speed and a valve-closing response rate of the drain switching valve, and switches a valve timing control mode from the maximum speed control to the holding control when the deviation between the target displacement angle and the actual displacement angle is less than the determination threshold value during the maximum speed controlling.

3. A controller for a vane-type variable valve timing adjusting mechanism according to claim 1, wherein:
the control means detects a changing speed of the actual displacement angle during the maximum speed control and estimates the maximum speed based upon the detected value.

4. A controller for a vane-type variable valve timing adjusting mechanism according to claim 1, wherein:
the control means estimates the maximum speed based upon a pressure and a temperature of oil supplied to the variable valve timing adjusting mechanism or information correlating thereto.

5. A controller for a vane-type variable valve timing adjusting mechanism according to claim 3, wherein:
the control means includes means for learning the maximum speed for each operating condition.

6. A controller for a vane-type variable valve timing adjusting mechanism according to claim 1, wherein:
the control means estimates a displacement amount of the variable valve timing adjusting mechanism from a point when a valve timing control mode is switched to the holding control to a point when the variable operation of the variable valve timing adjusting mechanism actually stops, and sets timing for switching the valve timing control mode from the maximum speed control to the holding control based upon the estimated value of the displacement amount.

7. A controller for a vane-type variable valve timing adjusting mechanism according to claim 6, wherein:
the control means estimates the displacement amount of the variable valve timing adjusting mechanism from a point when the valve timing control mode is switched to the holding control to a point when the variable operation of the variable valve timing adjusting mechanism actually stops, and switches the valve timing control mode from the maximum speed control to the holding control when the deviation between the target displacement angle and the actual displacement angle is equal to the estimated value of the displacement amount during the maximum speed control.

8. A controller for a vane-type variable valve timing adjusting mechanism according to claim 6, wherein:
the control means estimates a displacement amount of the variable valve timing adjusting mechanism to a point when the variable operation of the variable valve timing adjusting mechanism actually stops by using a model simulating a hydraulic response delay of the variable operation of the variable valve timing adjusting mechanism.

9. A controller for a vane-type variable valve timing adjusting mechanism according to claim 1, wherein:
the control means sets switching timing between the maximum speed control and the holding control in such a manner that a switching characteristic therebetween has hysteresis.

10. A controller for a vane-type variable valve timing adjusting mechanism according to claim 1, wherein:
the control means controls the hydraulic control valve in a such a manner as to reduce the deviation between the target displacement angle and the actual displacement angle in a state where the drain switching valves corresponding to both of the advance hydraulic chamber and the retard hydraulic chamber are closed during the holding control.

11. A controller for a vane-type variable valve timing adjusting mechanism according to claim 1, wherein:
the hydraulic switching valve is integral with the hydraulic control valve.

12. A controller for a vane-type variable valve timing adjusting mechanism in which each of a plurality of vane accommodating chambers formed in a housing of the vane-type variable valve timing adjusting mechanism is divided into an advance hydraulic chamber and a retard hydraulic chamber by a vane, the controller comprising:
a first one-way valve disposed in a hydraulic supply passage of the advance hydraulic chamber in at least one of the vane accommodating chambers for preventing reverse flow of operating oil from the advance hydraulic chamber;
a first drain control valve disposed in a first drain oil passage bypassing the first one-way valve and driven by a hydraulic pressure;
a second one-way valve disposed in a hydraulic supply passage of the retard hydraulic chamber in at least one of the vane accommodating chambers for preventing reverse flow of operating oil from the retard hydraulic chamber;
a second drain control valve disposed in a second drain oil passage bypassing the second one-way valve and driven by the hydraulic pressure;
a first hydraulic control valve for controlling the hydraulic pressure supplied to the variable valve timing adjusting mechanism;
a second hydraulic control valve for controlling the hydraulic pressure driving the first and second drain control valves; and
a control means for controlling the first hydraulic control valve and the second hydraulic control valve, wherein:
the control means, in order that the actual displacement angle of the variable valve timing adjusting mechanism is controlled to be the target displacement angle, performs a holding control to close the drain control valve disposed in the hydraulic supply passage of the advance hydraulic chamber or the retard hydraulic chamber where the operating oil is discharged, based upon the target displacement angle and the actual displacement angle when the actual displacement angle is brought to be close to the target displacement angle.

13. A controller for a vane-type variable valve timing adjusting mechanism according to claim 12, wherein:
the control means, in order that the actual displacement angle of the variable valve timing adjusting mechanism is controlled to be the target displacement angle, performs the holding control based upon a deviation between the target displacement angle and the actual displacement angle when the actual displacement angle is brought to be close to the target displacement angle.

14. A controller for a vane-type variable valve timing adjusting mechanism according to claim 12, wherein:
the control means, in order that the actual displacement angle of the variable valve timing adjusting mechanism is controlled to be the target displacement angle, performs the holding control when the deviation between the target displacement angle and the actual displacement angle is less than a first predetermined value.

15. A controller for a vane-type variable valve timing adjusting mechanism according to claim 14, wherein:
the control means opens the drain control valve disposed in the hydraulic supply passage of the advance hydraulic chamber or the retard hydraulic chamber where the operating oil is discharged when the deviation between the target displacement angle and the actual displacement angle is greater than the first predetermined value, whereby performing a drive control for driving the variable valve timing adjusting mechanism in a direction of the target displacement angle at more than a predetermined speed, and
the control means performs the holding control when the deviation between the target displacement angle and the actual displacement angle is less than the first predetermined value.

16. A controller for a vane-type variable valve timing adjusting mechanism according to claim 15, wherein:
the control means sets the first predetermined value based upon a driving speed and a valve-closing characteristic of the drain control valve during the drive control.

17. A controller for a vane-type variable valve timing adjusting mechanism according to claim 15, wherein:
the control means detects a changing speed of the actual displacement angle during the drive control to estimate the driving speed based upon the detected value.

18. A controller for a vane-type variable valve timing adjusting mechanism according to claim 15, wherein:
the control means estimates the driving speed based upon a pressure and a temperature of oil supplied to the variable valve timing adjusting mechanism or information correlating thereto.

19. A controller for a vane-type variable valve timing adjusting mechanism according to claim 17, wherein:
the control means includes means for learning the driving speed for each operating condition.

20. A controller for a vane-type variable valve timing adjusting mechanism according to claim 16, wherein:
the driving speed is a driving speed at the time of driving the variable valve timing adjusting mechanism in a direction of the target displacement angle at a maximum speed or at a high speed close thereto during the drive control.

21. A controller for a vane-type variable valve timing adjusting mechanism according to claim 15, wherein:
the control means estimates a displacement amount of the variable valve timing adjusting mechanism from a point when a valve timing control mode is switched to the holding control to a point when the variable operation of the variable valve timing adjusting mechanism actually stops, and sets timing for switching the valve timing control mode from the drive control to the holding control based upon the estimated value of the displacement amount.

22. A controller for a vane-type variable valve timing adjusting mechanism according to claim 21, wherein:
the control means estimates the displacement amount of the variable valve timing adjusting mechanism from a point when the valve timing control mode is switched to the holding control to a point when the variable operation of the variable valve timing adjusting mechanism actually stops and switches the valve timing control mode from the drive control to the holding control when the deviation between the target displacement angle and the actual displacement angle is brought to be equal to the estimated value of the displacement amount during the drive control.

23. A controller for a vane-type variable valve timing adjusting mechanism according to claim 21, wherein:
the control means estimates the displacement amount of the variable valve timing adjusting mechanism to a point when the variable operation of the variable valve timing adjusting mechanism actually stops by using a model simulating a hydraulic response delay of the variable operation of the variable valve timing adjusting mechanism.

24. A controller for a vane-type variable valve timing adjusting mechanism according to claim 15, wherein:
the control means sets switching timing in such a manner that a switching characteristic between the drive control and the holding control has hysteresis.

25. A controller for a vane-type variable valve timing adjusting mechanism according to claim 15, wherein:
the control means controls the hydraulic control valve in such a manner as to reduce the deviation between the target displacement angle and the actual displacement angle in a state where the drain switching valves in both sides of the advance hydraulic chamber and the retard hydraulic chamber are closed during the holding control.

26. A controller for a vane-type variable valve timing adjusting mechanism according to claim 15, wherein:
the first hydraulic control valve and the second hydraulic control valve are structured to be independently controllable with each other; and
the control means includes first control means for controlling the first hydraulic control valve to open/close the each drain control valve, and second control means for controlling the second hydraulic control valve to control the actual displacement angle of the variable valve timing adjusting mechanism to be the target displacement angle.

27. A controller for a vane-type variable valve timing adjusting mechanism according to claim 15, wherein:
the first hydraulic control valve and the second hydraulic control valve are structured to be integral with each other; and
the control means includes third control means for controlling the first hydraulic control valve to open/close the each drain control valve and for controlling the second hydraulic control valve to control the actual displacement angle of the variable valve timing adjusting mechanism to be the target displacement angle.

28. A controller for a vane-type variable valve timing adjusting mechanism in which each of a plurality of vane accommodating chambers formed in a housing of the vane-type variable valve timing controller is divided into an advance hydraulic chamber and a retard hydraulic chamber by a vane, the controller comprising:
a first one-way valve in a hydraulic supply passage of the advance hydraulic chamber in at least one of the vane accommodating chambers for preventing reverse flow of operating oil from the advance hydraulic chamber;
a first drain control valve disposed in a first drain oil passage bypassing the first one-way valve and driven by a hydraulic pressure;
a second one-way valve disposed in a hydraulic supply passage of the retard hydraulic chamber in at least one of the vane accommodating chambers for preventing reverse flow of operating oil from the retard hydraulic chamber;
a second drain control valve disposed in a second drain oil passage bypassing the second one-way valve and driven by the hydraulic pressure;
a single hydraulic control valve for controlling the hydraulic pressure supplied to the each drain control valve and the variable valve timing adjusting mechanism; and
control means for controlling the hydraulic control valve to drive the each drain control valve and for controlling the hydraulic pressure supplied to the variable valve timing adjusting mechanism, wherein:
the control means, in order that the actual displacement angle of the variable valve timing adjusting mechanism is controlled to be the target displacement angle, performs a holding control to close the drain control valve disposed in the hydraulic supply passage of the advance hydraulic chamber or the retard hydraulic chamber where the operating oil is discharged, based upon the target displacement angle and the actual displacement angle when the actual displacement angle is brought to be close to the target displacement angle.

29. A controller for a vane-type variable valve timing adjusting mechanism according to claim 28, wherein:
the control means, in order that the actual displacement angle of the variable valve timing adjusting mechanism is controlled to be the target displacement angle, performs the holding control based upon the deviation between the target displacement angle and the actual displacement angle when the actual displacement angle is brought to be close to the target displacement angle.

30. A controller for a vane-type variable valve timing adjusting mechanism according to claim 28, wherein:
the control means, in order that the actual displacement angle of the variable valve timing adjusting mechanism is controlled to be the target displacement angle, performs the holding control when the deviation between the target displacement angle and the actual displacement angle is not more than a predetermined value.

31. A controller for a vane-type variable valve timing adjusting mechanism according to claim 30, wherein:
the control means opens the drain control valve disposed in the hydraulic supply passage of the advance hydraulic chamber or the retard hydraulic chamber where the operating oil is discharged when the deviation between the target displacement angle and the actual displacement angle is greater than the predetermined value, whereby performing a drive control for driving the variable valve timing adjusting mechanism in a direction of the target displacement angle at more than a predetermined speed; and
the control means performs the holding control when the deviation between the target displacement angle and the actual displacement angle is not more than the predetermined value.

32. A controller for a vane-type variable valve timing adjusting mechanism according to claim 31, wherein:
the control means sets the predetermined value based upon a driving speed and a valve-closing characteristic of the drain control valve during the drive control.

33. A controller for a vane-type variable valve timing adjusting mechanism according to claim 32, wherein:
the control means detects a changing speed of the actual displacement angle during the drive control to estimate the driving speed based upon the detected value.

34. A controller for a vane-type variable valve timing adjusting mechanism according to claim 32, wherein:
the control means estimates the driving speed based upon a pressure and a temperature of oil supplied to the variable valve timing adjusting mechanism or information correlating thereto.

35. A controller for a vane-type variable valve timing adjusting mechanism according to claim 33, wherein:
the control means includes means for learning the driving speed for each operating condition.

36. A controller for a vane-type variable valve timing adjusting mechanism according to claim 32, wherein:
the driving speed is a driving speed at the time of driving the variable valve timing adjusting mechanism in a direction of the target displacement angle at a maximum speed or at a high speed close thereto during the drive control.

37. A controller for a vane-type variable valve timing adjusting mechanism according to claim 28, wherein:
the control means estimates a displacement amount of the variable valve timing adjusting mechanism from a point when a valve timing control mode is switched to the holding control to a point when the variable operation of the variable valve timing adjusting mechanism actually stops to set timing for switching the valve timing control mode from the drive control to the holding control based upon the estimated value of the displacement amount.

38. A controller for a vane-type variable valve timing adjusting mechanism according to claim 37, wherein:
the control means estimates the displacement amount of the variable valve timing adjusting mechanism from a point when the valve timing control mode is switched to the holding control to a point when the variable operation of the variable valve timing adjusting mechanism actually stops to switch the valve timing control mode from the drive control to the holding control when the deviation between the target displacement angle and the actual displacement angle is brought to be equal to the estimated value of the displacement amount during the drive control.

39. A controller for a vane-type variable valve timing adjusting mechanism according to claim 37, wherein:
the control means estimates the displacement amount of the variable valve timing adjusting mechanism to a point when the variable operation of the variable valve timing adjusting mechanism actually stops by using a model simulating a hydraulic response delay of the variable operation of the variable valve timing adjusting mechanism.

40. A controller for a vane-type variable valve timing adjusting mechanism according to claim 28, wherein:
the control means sets switching timing in such a manner that a switching characteristic between the drive control and the holding control has hysteresis.

41. A controller for a vane-type variable valve timing adjusting mechanism according to claim 28, wherein:
the control means controls the hydraulic control valve in a such a manner as to reduce the deviation between the target advance angle and the actual advance angle in a state where the drain switching valves in both sides of the advance hydraulic chamber and the retard hydraulic chamber are closed during the holding control.

42. A controller for a vane-type variable valve timing adjusting mechanism according to claim 28, wherein:
the hydraulic control valve opens/closes the first drain control valve to open/close the first drain oil passage and opens/closes the second drain control valve to open/close the second drain oil passage.
